(19) United States
(12) Patent Application Publication
(10) Pub. No.: US 2025/0367482 A1
(43) Pub. Date: Dec. 4, 2025

(54) SYSTEM AND METHOD FOR FIREFIGHTING

(71) Applicant: Dwight WILLIAMS, Brady, TX (US)

(72) Inventor: Dwight WILLIAMS, Brady, TX (US)

(21) Appl. No.: 19/225,410

(22) Filed: Jun. 2, 2025

Related U.S. Application Data
(60) Provisional application No. 63/655,155, filed on Jun. 3, 2024.
(60) Provisional application No. 63/665,451, filed on Jun. 28, 2024.

(51) Int. Cl. A62C 3/00; A62C 5/02

(52) U.S. Cl. CPC A62C 3/002; A62C 5/02

(57) ABSTRACT

In one or more embodiments a system for firefighting may be described. The system may include a tank configured to hold liquid, which may be contained within a plurality of dike walls and having a top end, a plurality of over the top delivery devices configured to dispense water or foam, a plurality of auxiliary delivery devices configured to dispense water or foam, and a connection system. The plurality of over the top delivery devices and the plurality of auxiliary delivery devices may be positioned above the top end of the tank and connected a source of water or foam by the connection system. The connection system may deliver water or foam from outside the plurality of dike walls to inside the plurality of dike walls.

### BACKGROUND

AFFF (Aqueous Film Forming Foam) type firefighting foams have been used for fifty plus years. Now, due to governmental pressure, there is a drive to abandon these AFFF foams. AFFF foams have been very effective and have extinguished the largest 3 tank fires in the history of flammable liquid firefighting. Current non-AFFF type foams do not perform as well as the foam concentrates that have been used since the early 70's.

Current non-AFFF type foams, including and often referred to as SFFFs (Synthetic Fluorine-Free Foams), do not produce a film. This type of foam is often referred to as “bubbly technology.” The petroleum industry is now faced with using a foam that has no history of being successful on a fire of any size.

Additionally, existing fire suppression systems for large tanks often involve over the top foam dispensers. This method of dispensing foam often leaves a gap area called the “smiley zone” where the fire continues to burn for several minutes, which can reduce the effectiveness of putting out the fire.

### SUMMARY

In one or more embodiments a system for firefighting may be described. The system may include a tank configured to hold liquid, which may be contained within a plurality of dike walls and having a top end, a plurality of over the top delivery devices configured to dispense water or foam, a plurality of auxiliary delivery devices configured to dispense water or foam, and a connection system. The plurality of over the top delivery devices and the plurality of auxiliary delivery devices may be positioned above the top end of the tank and connected a source of water or foam by the connection system. The connection system may deliver water or foam from outside the plurality of dike walls to inside the plurality of dike walls.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary firefighting system.

FIG. 2 shows an exemplary firefighting system for extinguishing a smile zone.

FIG. 3 shows a flow diagram of an exemplary firefighting method.

FIG. 4 shows an exemplary firefighting nozzle.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

In one or more exemplary embodiment a method and tool for firefighting may be disclosed.

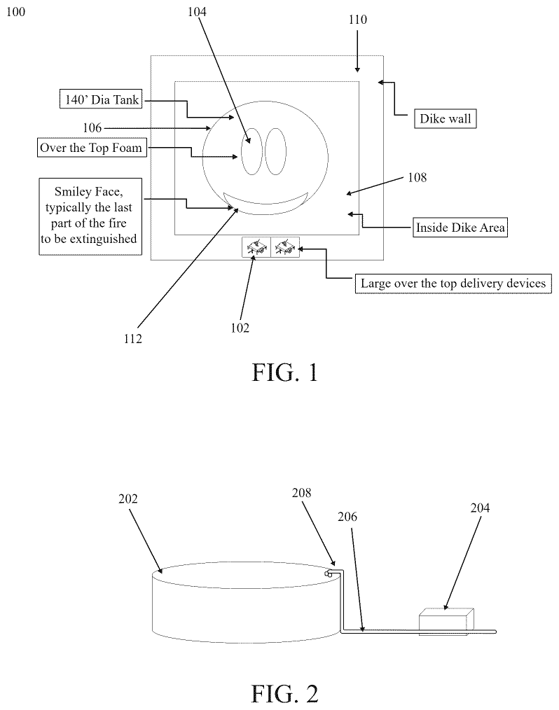

Referring to FIG. 1, an exemplary firefighting system 100 for fighting tank fires may be shown and described. The system may include one or more large over the top delivery devices 102. The over the top delivery devices 102 may release or deliver over the top foam 104 on a tank 106. In some embodiments, the over the top foam 104 may be, for example, Class B AR/AFFF, SFFFFoam concentrates, or other foam concentrates. In some embodiments the top delivery devices 102 may be centered over the tank 106, while in other embodiments the top delivery devices 102 may be off center in any direction. The tank 106 may contain a flammable or at-risk substance. The tank may further be contained within an interior area 108 of a dike wall 110. It may be understood that the over the top foam 104 may be used to suppress fires within the tank 106, for example by smothering the flame and preventing oxygen from reaching the flames. The portion of the tank wherein fires tend to be last extinguished may be understood to be a “smiley face” zone 112. The “smiley face” zone 112 may be, for example, the portion along the edge of the tank 106 farther away from where the over the top foam 104 is dispensed.

Referring to FIG. 2, an exemplary firefighting system for extinguishing a smile zone fire may be shown and described. In an exemplary embodiment the system may include a tank 202 which may hold a flammable or other at-risk substance. It may be understood that in at least some embodiments the tank may be a metallic tank, and may have a storage capacity of, for example, 500 to 10,000 barrels. The tank 202 may be contained within a dike wall 204. A connection system 206 for a water and/or a finished foam solution may deposit the water and/or finished foam solution inside the tank 202. In some embodiments, the finished foam solution may be, for example, Class B AR/AFFF, SFFFFoam concentrates, or other foam concentrates. The connection system may be, for example, a pipe system. The connection system 206 may be connected to a reservoir or storage area for holding the water and/or finished foam solution. The reservoir or storage area may be understood to be outside the dike wall 204. In some embodiments, the connection system 206 may bypass the dike wall 204. For example, in some embodiments, the connection system 206 may be built through the dike wall 204. In other exemplary embodiments, the connection system 206 may bypass the dike wall 204 by going over or below it. In some embodiments, the dike wall 204 may include a mount to allow the connection system to be mounted or fixed in place. The connection system may removably connected to the mount or permanently fixed. In other embodiments, the mount may be configured to receive other components of the system.

The connection system 206 may be hung on a wall of the tank 202 and/or may be built into the tank 202. For example, in some embodiments the connection system 206 may be hanged on, looped to, welded to, or otherwise secured to the tank 202. In some embodiments the connection system may be placed temporarily, for example using C-clamps, in order to address a localized or particular issue, for example a particularly bad fire season, or to expedite installation. In other embodiments the connection system may be permanently installed using chokers and/or chains, or any other method of attaching the connection system to the edge of the tank.

In some exemplary embodiments, the connection system 206 may be connected to at least one auxiliary delivery device 208. The auxiliary delivery device 208 may be placed in such a way as to extinguish flames in the “smiley face” zone 112. This may allow the system to save water or foam by targeting the last remaining area with flames.

In some embodiments a plurality of connection systems and a plurality of auxiliary delivery devices may be used, and the plurality of auxiliary delivery devices may be placed relative to one or more over the top delivery systems or relative to the direction of the wind. For example, viewing the top end of the tank 202 as a clock, a 12 o'clock position may be defined a wind direction. The wind direction may be defined as the side toward which the wind is blowing and a 6 o'clock position may be defined as the side that the wind is blowing from. In other embodiments, the wind direction may be defined as the direction that the wind usually blows in. If the one or more over the top delivery systems are arranged such that the 5 to 7 o'clock position are the last to receive foam (i.e. the “smiley zone”) then one auxiliary delivery device may be placed at the 5 o'clock position and another may be placed at the 7 o'clock position of the tank. In other embodiments a different number of auxiliary delivery devices may be dispersed through the same zone, e.g. 3 systems placed at 5′ o'clock, 6 o'clock, 7 o'clock, and/or the auxiliary delivery devices may be staggered, for example one at the 4′30 position and one at the 7′30 position.

In some embodiments the auxiliary delivery devices may be angled to obtain best coverage, for example the 5 o'clock and 7 o'clock positions may be angled at 45 or 90 degrees. The number of distribution systems placed may be dependent on any of a number of factors, for example a larger tank may result in 2 or 3 distribution systems being placed, or additional systems may be placed in particularly at risk places.

It may be understood that by placing distribution systems only at the most at risk areas, cost may be saved while still efficiently increasing firefighting capabilities. Additionally tank downtime may be avoided compared to installing a system that goes all the way around the tank.

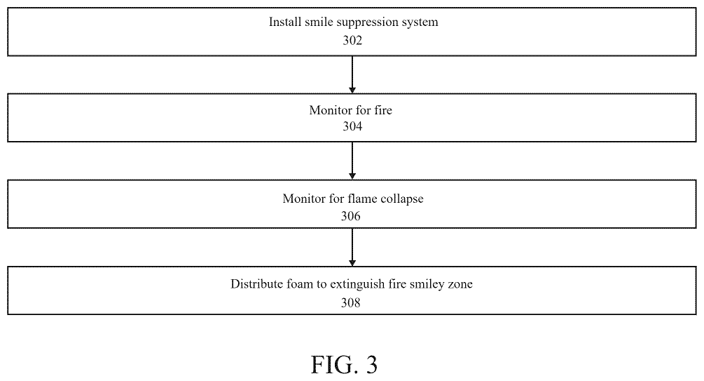

An exemplary method for distributing firefighting material through the system of FIG. 3. may now be described. In a first step, a smiley suppression system may be installed 302. In a second step, a user may monitor for the presence of fire 304. The monitoring may be done through a plurality of sensors. Sensors may include, for example, cameras, heat sensors, smoke detectors, microphones, lidar, or infrared sensors, to name a few. In addition to monitoring for the presence of fire, sensors may also be used to detect flame collapse, monitor the amount of water or foam remaining, and/or collect various other useful data.

In some embodiments, the method may be performed by a processor receiving input from a plurality of sensors. The system may be completely automated or it may be performed in part or entirely by a human operator. In some exemplary embodiments, a processor or a user may monitor for flame collapse 306. If flame collapse is detected, a processor or a user may cause at least one of the over the top delivery systems to distribute water or foam to extinguish fire in the smiley zone 308. In other exemplary embodiments, one or more auxiliary delivery devices 208 may be engaged prior to flame collapse. In some embodiments, one or more auxiliary delivery devices may dispense water or foam concurrently with at least one over the top delivery device 102.

In an exemplary embodiment where there is above a threshold amount of water and/or foam the connection system may be immediately turned on once a fire is detected. If below a threshold amount of water and/or foam is available instead the water and/or foam may not be delivered until flame collapse, or when the largest part of the tank fire has been extinguished. In some exemplary embodiments, flame collapse may be defined as a state in which 50% or more of the flame is extinguished. In other embodiments, flame collapse may be defined as a state in which 80% or more of the flame is extinguished. It may be understood the water and/or foam may be distributed through the connection system until the entire surface area of the tank is covered.

It may be understood that the above system and method may increase the amount of foam inside the tank shell on fire, and may put a foam blanket up against the hot inner wall of the tank, thereby increases the probability that the tank fire is extinguished.

In an exemplary embodiment a firefighting tool designed to work with non-fluorinated foam products may be described. It may be understood that the tool may address the need for large expansion of non-fluorinated foams.

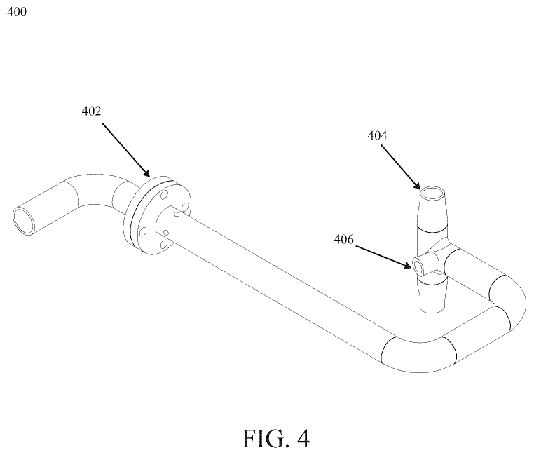

Referring to FIG. 4, an exemplary firefighting nozzle 400 may be shown and described. The firefighting nozzle 400 may include at least one flange 402. The at least one flange 402 may, in some embodiments, connect the firefighting nozzle 400 to the connection system 206. The firefighting nozzle 400 may also include at least one tangential nozzle 404, which may dispense water or foam. The firefighting nozzle 400 may also include at least one radial nozzle 406, which may dispense water or foam. In some embodiments, the firefighting nozzle 400, the tangential nozzle 404, and/or the radial nozzle 406 may be the same as the auxiliary delivery device 208.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for firefighting comprising,
a tank configured to hold liquid, the tank being contained within a plurality of dike walls and having a top end;
a plurality of over the top delivery devices configured to dispense water or foam;
a plurality of auxiliary delivery devices configured to dispense water or foam; and
a connection system;
wherein the plurality of over the top delivery devices are positioned above the top end of the tank;
wherein the plurality of over the top delivery devices are connected to a source of water or foam;
wherein the plurality of auxiliary delivery devices are positioned above an edge of the top end of the tank and are connected a source of water or foam by the connection system;
wherein the connection system delivers water or foam from outside the plurality of dike walls to inside the plurality of dike walls.

2. The system of claim 1, wherein the water or foam comprises nonfluorinated flame retardant foam.

3. The system of claim 1, further comprising at least two auxiliary delivery devices.

4. The system of claim 3, wherein the at least two auxiliary delivery devices include a first auxiliary device positioned at a five o'clock position and a second auxiliary device positioned at a seven o'clock position;
the five o'clock and seven o'clock positions being defined relative to a twelve o'clock position;
the twelve o'clock position being defined as a wind direction.

5. The system of claim 4, further comprising a third auxiliary device positioned at a six o'clock position.

6. The system of claim 1, further comprising a processor and a plurality of sensors,
wherein the processor is configured to
receive input from the plurality of sensors,
compare the input to a predetermined threshold value, and
induce at least one of the auxiliary delivery devices to dispense water or foam if the input exceeds the predetermined threshold value.

7. The system of claim 6, wherein the processor is configured to
determine whether flame collapse has occurred based on the input from the plurality of sensors, and
induce at least one of the auxiliary delivery devices to dispense water or foam if flame collapse has occurred.

8. The system of claim 6, wherein flame collapse is defined as a state in which 50% or more of the flame is extinguished.

9. The system of claim 6, wherein flame collapse is defined as a state in which 80% or more of the flame is extinguished.

10. The system of claim 6, wherein the processor is configured to
determine whether fire is present based on the input from the plurality of sensors,
induce at least one of the over the top delivery devices to dispense water or foam,
determine whether flame collapse has occurred based on the input from the plurality of sensors, and
induce at least one of the auxiliary delivery devices to dispense water or foam if flame collapse has occurred.

11. A method for firefighting comprising,
defining a twelve o'clock position as a wind direction;
defining a five o'clock position and a seven o'clock position therefrom;
installing at least one auxiliary delivery device in the five o'clock position or the seven o'clock position, wherein the at least one auxiliary delivery device is positioned above a top end of a tank configured to hold liquid;
taking data readings through a plurality of sensors;
transferring the data readings from at least one of the plurality of sensors to a processor;
processing the data readings with the processor;
determining whether fire is present based on the input from the plurality of sensors;
inducing at least one over the top delivery device to dispense water or foam if fire is present;
determining whether flame collapse has occurred based on the data readings from the plurality of sensors; and
inducing at least one over auxiliary device to dispense water or foam if flame collapse has occurred.

12. The method of claim 11, wherein flame collapse is defined as a state in which 50% or more of the flame is extinguished.

13. The method of claim 11, wherein flame collapse is defined as a state in which 80% or more of the flame is extinguished.
